(19) United States
(12) Patent Application Publication
(10) Pub. No.: US 2007/0202415 A1
(43) Pub. Date: Aug. 30, 2007

(54) Proton-Conducting Polymer Membrane Comprising At Least One Porous Carrier Material, And Use Thereof In Fuel Cells

(75) Inventors: Joachim Kiefer, Losheim Am See (DE); Oemer Uensal, Mainz (DE)

Correspondence Address: CONNOLLY BOVE LODGE & HUTZ, LLP, P O BOX 2207, WILMINGTON, DE, 19899, US

(73) Assignee: PEMEAS GMBH, FRANKFURT (DE)

(21) Appl. No.: 10/570,722

(22) PCT Filed: Sep. 4, 2004
(86) PCT No.: PCT/EP04/09901

§ 371 Date: Dec. 22, 2006

(30) Foreign Application Priority Data
Sep. 4, 2003 (DE) 103 40 929.7

(51) Int. Cl. H01M 8/10

(52) U.S. Cl. 429/309; 429/314; 429/33

(57) ABSTRACT

The present invention relates to a proton-conducting polymer membrane comprising polymers comprising at least one porous carrier material and polymers comprising phosphonic acid groups, obtainable by polymerizing monomers comprising phosphonic acid groups.

The present invention relates to a proton-conducting polymer membrane comprising at least one porous carrier material, which has a wide variety of possible uses owing to its outstanding chemical and thermal properties and is especially suitable as a polymer-electrolyte membrane (PEM) in so-called PEM fuel cells.

A fuel cell typically comprises an electrolyte and two electrodes separated by the electrolyte. In the case of a fuel cell, a fuel such as hydrogen gas or a methanol-water mixture is fed to one of the two electrodes, and an oxidizing agent such as oxygen gas or air is fed to the other electrode, thus converting chemical energy from the fuel oxidation directly to electrical energy. The oxidation reaction forms protons and electrons.

The electrolyte is permeable to hydrogen ions, i.e. protons, but not to reactive fuels such as hydrogen gas or methanol and the oxygen gas.

A fuel cell generally has a plurality of individual cells known as MEUs (membrane-electrode unit) which each comprise an electrolyte and two electrodes separated by the electrolyte.

The electrolytes used for the fuel cell include solids such as polymer electrolyte membranes or liquids such as phosphoric acid. In recent times, polymer electrolyte membranes have attracted attention as electrolytes for fuel cells. In principle, a distinction can be drawn between 2 categories of polymer membranes.

The first category includes cation exchange membranes consisting of a polymer skeleton which comprises covalently bonded acid groups, preferably sulfonic acid groups. The sulfonic acid group is converted to an anion with release of a hydrogen ion and therefore conducts protons. The mobility of the proton and hence the proton conductivity is directly linked to the water content. As a result of the very good miscibility of methanol and water, such cation exchange membranes have a high methanol permeability and are therefore unsuitable for applications in a direct methanol fuel cell. When the membrane dries out, for example, as a consequence of high temperature, the conductivity of the membrane and consequently the performance of the fuel cell decrease drastically. The operating temperatures of fuel cells comprising such cation exchange membranes is thus restricted to the boiling point of water. The moistening of the fuels constitutes a great technical challenge for the use of polymer electrolyte membrane fuel cells (PEMFC), in which conventional, sulfonated membranes, for example Nafion, are used.

Thus, the materials used for polymer electrolyte membranes are, for example, perfluorosulfonic acid polymers. The perfluorosulfonic acid polymer (for example Nafion) generally has a perfluorohydrocarbon skeleton, such as a copolymer of tetrafluoroethylene and trifluorovinyl, and, bonded thereto, a side chain having a sulfonic acid group, such as a side chain having a sulfonic acid group bonded to a perfluoroalkylene group.

The cation exchange membranes are preferably organic polymers having covalently bonded acid groups, especially sulfonic acid. Processes for sulfonating polymers are described in F. Kucera et. al. Polymer Engineering and Science 1988, Vol. 38, No. 5, 783-792.

The most important types of cation exchange membranes which have gained commercial significance for use in fuel cells are detailed below:

The most important representative is the perfluorosulfonic acid polymer Nafion® (U.S. Pat. No. 3,692,569). As described in U.S. Pat. No. 4,453,991, this polymer can be brought into solution and then used in the form of an ionomer. Cation exchange membranes are also obtained by filling a porous support material with such an ionomer. A preferred support material is expanded Teflon (U.S. Pat. No. 5,635,041).

As described in U.S. Pat. No. 5,422,411, a further perfluorinated cation exchange membrane can be prepared by copolymerization from trifluorostyrene and sulfonyl-modified trifluorostyrene. Composite membranes consisting of a porous support material, especially expanded Teflon, filled with ionomers consisting of such sulfonyl-modified trifluorostyrene copolymers are described in U.S. Pat. No. 5,834,523.

U.S. Pat. No. 6,110,616 describes copolymers of butadiene and styrene and their subsequent sulfonation for the production of cation exchange membranes for fuel cells.

A further class of partly fluorinated cation exchange membranes can be produced by radiative grafting and subsequent sulfonation. As described in EP667983 or DE 19844645, a grafting reaction is preferably carried out with styrene on a polymer film irradiated beforehand. In a subsequent sulfonation reaction, the sulfonation of the side chains is then effected. Simultaneously with the grafting, a crosslinking can also be carried out and thus the mechanical properties changed.

In addition to the above membranes, a further class of nonfluorinated membranes has also been developed by sulfonating high-temperature-stable thermoplastics. Thus, membranes of sulfonated polyether ketones (DE4219077, EP96/01177), sulfonated polysulfone (J. Membr. Sci. 83 (1993) p. 211) or sulfonated polyphenylene sulfide (DE19527435) are known. Ionomers prepared from sulfonated polyether ketones are described in WO 00/15691.

Also known are acid-base blend membranes which are produced as described in DE19817374 or WO 01/18894 by mixtures of sulfonated polymers and basic polymers.

To further improve the membrane properties, a cation exchange membrane known from the prior art can be mixed with a high-temperature-stable polymer. The preparation and properties of cation exchange membranes consisting of blends of sulfonated PEK and a) polysulfones (DE4422158), b) aromatic polyamides (42445264) or c) polybenzimidazole (DE19851498) have been described.

Sulfonated polybenzimidazoles are also already known from the literature. For instance, U.S. Pat. No. 4,634,530 describes a sulfonation of an undoped polybenzimidazole film with a sulfonating agent such as sulfuric acid or oleum in the temperature range up to 100° C.

Moreover, Staiti et al (P. Staiti in J. Membr. Sci. 188 (2001) 71) have described the preparation and properties of sulfonated polybenzimidazoles. For this purpose, it was not possible to undertake the sulfonation on the polymer in solution. When the sulfonating agent is added to the PBI/DMAc solution, the polymer precipitates out. For the sulfonation, a PBI film was prepared first and this was immersed into dilute sulfuric acid. For the sulfonation, the samples were then treated at temperatures of approx. 475° C. over 2 minutes. The sulfonated PBI membranes have only a maximum conductivity of 7.5×10⁻⁵ S/cm at a temperature of 160° C. The maximum ion exchange capacity is 0.12 meq/g. It was likewise shown that PBI membranes sulfonated in this way are unsuitable for use in a fuel cell.

The production of sulfoalkylated PBI membranes by the reaction of a hydroxyethyl-modified PBI with a sultone is described in U.S. Pat. No. 4,997,892.

Based on this technology, it is possible to prepare sulfopropylated PBI membranes (Sanui et al in Polym. Adv. Techn. 11 (2000) 544). The proton conductivity of such membranes is 10⁻³ S/cm and is thus too low for applications in fuel cells, in which 0.1 S/cm is required.

In addition, polymer membranes which have a porous material are known from WO 00/22684. The water content of the membrane is preferably from 20 to 100% by weight based on the dry weight of the membrane. Accordingly, the proton conductivity is determined by the water content.

A disadvantage of all of these cation exchange membranes is the fact that the membrane has to be moistened, the operating temperature is restricted to 100° C. and the membranes have a high methanol permeability. The cause of these disadvantages is the conductivity mechanism of the membrane, in which the transport of the protons is coupled to the transport of the water molecules. This is referred to as the “vehicle mechanism” (K.-D. Kreuer, Chem. Mater. 1996, 8, 610-641).

As a second category, polymer electrolyte membranes comprising complexes of basic polymers and strong acids have been developed. For instance, WO96/13872 and the corresponding U.S. Pat. No. 5,525,436 describe a process for producing a proton-conducting polymer electrolyte membrane, in which a basic polymer such as polybenzimidazole is treated with a strong acid such as phosphoric acid, sulfuric acid, etc.

J. Electrochem. Soc., volume 142, No. 7, 1995, p. L121-L123 describes the doping of a polybenzimidazole in phosphoric acid.

In the case of the basic polymer membranes known in the prior art, the mineral acid used to achieve the required proton conductivity (usually concentrated phosphoric acid) is added typically after the shaping of the polyazole film. The polymer serves as the carrier for the electrolyte consisting of the highly concentrated phosphoric acid. The polymer membrane fulfills further essential functions; in particular, it has to have a high mechanical stability and serve as a separator for the two fuels mentioned at the outset.

Important advantages of such a phosphoric acid-doped membrane is the fact that a fuel cell in which such a polymer electrolyte membrane is used can be operated at temperatures above 100° C. without a moistening of the fuels which is otherwise necessary. The reason for this is the property of the phosphoric acid of being able to transport the protons without additional water by means of the so-called Grotthus mechanism (K.-D. Kreuer, Chem. Mater. 1996, 8, 610-641).

The possibility of operation at temperatures above 100° C. gives rise to further advantages for the fuel cell system. Firstly, the sensitivity of the Pt catalyst toward gas impurities, especially CO, is greatly reduced. CO is formed as a by-product in the reformation of the hydrogen-rich gas of carbon-containing compounds, for example natural gas, methanol or petroleum, or else as an intermediate in the direct oxidation of methanol. Typically, the CO content of the fuel at temperatures of <100° C. has to be less than 100 ppm. At temperatures in the 150-200° range, however, even 10 000 ppm of CO or more can be tolerated (N. J. Bjerrum et. al. Journal of Applied Electrochemistry, 2001, 31, 773-779). This leads to substantial simplifications of the upstream reforming process and thus to cost reductions of the entire fuel cell system.

A great advantage of fuel cells is the fact that, in the electrochemical reaction, the energy of the fuel is converted directly to electrical energy and heat. The reaction product formed at the cathode is water. The by-product formed in the electrochemical reaction is thus heat. For applications in which only the current is utilized to drive electric motors, for example for automobile applications, or as a versatile replacement of battery systems, the heat has to be removed in order to prevent overheating of the system. For the cooling, additional energy-consuming units are necessary, which further reduce the overall electrical efficiency of the fuel cell. For stationary applications, such as for the central or decentral generation of power and heat, the heat can be utilized efficiently by existing technologies, for example heat exchangers. To increase the efficiency, high temperatures are desired. When the operating temperature is above 100° C. and the temperature difference between the ambient temperature and the operating temperature is large, it becomes possible to cool the fuel cell system more efficiently or to use small cooling surfaces, and to dispense with additional units in comparison to fuel cells which have to be operated at below 100° C. owing to the membrane moistening.

However, such a fuel cell system also has disadvantages in addition to these advantages. For instance, the lifetime of phosphoric acid-doped membranes is relatively limited. The lifetime is lowered distinctly especially by operation of the fuel cell below 100° C., for example at 80° C. However, it should be emphasized in this context that the cell has to be operated at these temperatures when the fuel cell is started up and shut down.

Furthermore, the performance, for example the conductivity of known membranes, still needs to be improved.

Moreover, the mechanical stability of known high-temperature membranes with high conductivity still needs to be improved.

Moreover, the known phosphoric acid-doped membranes cannot be used in the so-called direct methanol fuel cell (DMFC). However, such cells are of particular interest, since a methanol-water mixture is used as the fuel. When a known membrane based on phosphoric acid is used, the fuel cell fails after quite a short time.

It is therefore an object of the invention to provide a novel polymer electrolyte membrane which solves the problems laid out above. In particular, an inventive membrane should be producible in an inexpensive and simple manner. Furthermore, it is therefore an object of the present invention to provide polymer electrolyte membranes which exhibit high performance, especially a high conductivity over a wide temperature range. In this context, the conductivity, especially at high temperatures, shall be achieved without additional moistening. In this context, the membrane shall have a high mechanical stability in relation to its performance.

Moreover, a polymer electrolyte membrane shall be provided which can be used in many different fuel cells. For instance, the membrane shall be suitable in particular for fuel cells which utilize pure hydrogen and also numerous carbon-containing fuels, especially natural gas, petroleum, methanol and biomass, as the energy source. In particular, the membrane shall be usable in a hydrogen fuel cell and in a direct methanol fuel cell (DMFC).

In addition, the operating temperature shall be widened from <20° C. up to 200° C. without the lifetime of the fuel cell being very greatly lowered.

In addition, a polymer electrolyte membrane shall be provided which has a high mechanical stability, for example a high modulus of elasticity, a high tensile strength and a high fracture toughness.

These objects are achieved by a proton-conducting polymer membrane having all features of claim 1.

The present invention provides a proton-conducting polymer membrane comprising polymers comprising at least one porous carrier material and polymers comprising phosphonic acid groups, obtainable by polymerizing monomers comprising phosphonic acid groups.

An inventive membrane exhibits a high conductivity over a wide temperature range, which can be achieved even without additional moistening. In this context, an inventive membrane exhibits a relatively high mechanical stability.

Moreover, an inventive membrane can be produced in a simple and inexpensive manner.

Moreover, these membranes exhibit a surprisingly long lifetime. Moreover, a fuel cell which is equipped with an inventive membrane can be operated even at low temperatures, for example at 20° C., without the lifetime of the fuel cell being lowered very greatly as a result.

An inventive membrane exhibits a high conductivity over a wide temperature range, which is achieved even without additional moistening. Moreover, a fuel cell which is equipped with an inventive membrane can be operated even at low temperatures, for example at 80° C., without the lifetime of the fuel cell being lowered very greatly as a result.

An inventive polymer electrolyte membrane has a very low methanol permeability and is suitable especially for use in a DMFC. Thus, prolonged operation of a fuel cell with a multitude of fuels such as hydrogen, methanol or reformer gas which may be obtained, for example, from natural gas, petroleum or biomass is possible.

Moreover, membranes of the present invention have a high mechanical stability, especially a high modulus of elasticity, a high tensile strength and a high fracture toughness. Moreover, these membranes exhibit a surprisingly long lifetime.

In a particular aspect of the present invention, preferred proton-conducting polymer membranes are obtainable by a process comprising the steps of

A) imbibing at least one porous carrier material with a liquid which comprises monomers comprising phosphonic acid groups, and

B) polymerizing at least some of the monomers comprising phosphonic acid groups which have been introduced into the polymer film in step A).

Imbibing is understood to mean a weight increase of the porous carrier material of at least 3% by weight. The weight increase is preferably at least 5%, more preferably at least 10%.

The weight increase is determined gravimetrically from the mass of the porous carrier material before the imbibing mₒ and the mass of the polymer membrane after the polymerization in step B), m₂.
Q=(m₂−m₀)/m₀×100

The imbibing is effected preferably at a temperature above 0° C., in particular between room temperature (20° C.) and 180° C. in a liquid which preferably comprises at least 5% by weight of monomers comprising phosphonic acid groups. In addition, the imbibing may also be carried out at elevated pressure and with the aid of ultrasound. In this context, the limits arise from economic considerations and technical means.

The carrier material used for the imbibing generally has a thickness in the range from 5 to 1000 μm, preferably from 10 to 500 μm, in particular from 15 to 300 μm and more preferably between 30 and 250 μm. The production of such carrier materials is common knowledge, some of these being commercially available.

Porous means that the carrier material has a large proportion of a free volume which can be filled with a liquid. The free volume is preferably at least 30%, preferentially at least 50%, at least 70% and most preferably at least 90% by volume, based on the volume of the carrier material.

The pores of the carrier material may generally have a size in the range from 1 nm to 4000 nm, preferably from 10 nm to 1000 nm.

The pores of the carrier material may generally have a volume in the range from 1 nm³ to 1 μm³, preferably from 10 nm³ to 10 000 nm³.

The pore volume of the carrier material arises, for example, from the weight increase by the imbibing with liquid. In addition, this parameter can also be determined by the BET method (Brunauer, Emmett and Teller).

For example, porous carriers made of wovens, nonwovens or other porous materials may be used. Porous materials may are known especially on the basis of organic or inorganic foams.

Useful porous carrier materials include, for example, inorganic materials, for example ceramic materials such as silicon carbide SiC (U.S. Pat. No. 4,017,664 and U.S. Pat. No. 4,695,518) or inorganic glasses. These carriers may, for example, be a woven or a nonwoven.

A particularly suitable carrier may be manufactured from inorganic materials, for example from glass or materials which have at least one compound of a metal, a semimetal or a mixed metal or phosphorus with at least one element of main group 3 to 7. The material more preferably has at least one oxide of the elements Zr, Ti, Al or Si. The carrier may consist of an electrically insulating material, for example minerals, glasses, plastics, ceramics or natural substances. The carrier preferably has specific wovens, nonwovens or porous materials made of highly thermally resistant and highly acid-resistant quartz or glass. The glass preferably comprises at least one compound from the group of SiO₂, Al₂O₃ or MgO. In a further variant, the carrier comprises wovens, nonwovens or porous materials made of Al₂O₃ ceramic, ZrO₂ ceramic, TiO₂ ceramic, Si₃N₄ ceramic or SiC ceramic. In order to keep the overall resistance of the electrolyte membrane low, this carrier preferably has a very high porosity but also a low thickness of less than 1000 μm, preferably less than 500 μm and most preferably less than 200 μm. Preference is given to using carriers which have woven fibers of glass or quartz, the wovens preferably consisting of 11-tex yarns with 5-50 warp and filling threads and preferably 20-28 warp threads and 28-36 filling threads. Very particular preference is given to using 5.5-tex yarns with 10-50 warp and filling threads and preferably 20-28 warp threads and 28-36 filling threads.

The porous carriers used may also be organic polymer films having an open pore structure, polymer wovens or polymer nonwovens. The open pore volume is more than 30%, preferably more than 50% and most preferably more than 70%. The glass transition temperature of the organic base polymer of such a membrane is higher than the operating temperature of the fuel cell and is preferably at least 150° C., preferentially at least 160° C. and most preferably at least 180° C. Such membranes find use as separation membranes for ultrafiltration, gas separation, pervaporation, nanofiltration, microfiltration or hemodialysis.

Preferred polymers include polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyvinyl difluoride, polyhexafluoro-propylene, polyethylene-tetrafluoroethylene, copolymers of PTFE with hexafluoropropylene, with perfluoropropyl vinyl ether, with trifluoronitrosomethane, with carbalkoxyperfluoroalkoxy-vinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular those of norbornene; polymers having C—O bonds in the backbone, for example polyacetal, polyoxymethylene, polyethers, polypropylene oxide, polyepichlorohydrin, polytetrahydrofuran, polyphenylene oxide, polyether ketone, polyether ether ketone, polyether ketone ketone, polyether ether ketone ketone, polyether ketone ether ketone ketone, polyesters, in particular polyhydroxyacetic acid, polyethylene terephthalate, polybutylene terephthalate, polyhydroxybenzoate, polyhydroxypropionic acid, polypropionic acid, polypivalolactone, polycaprolactone, furan resins, phenol-aryl resins, polymalonic acid, polycarbonate; polymers having C—S bonds in the backbone, for example polysulfide ethers, polyphenylene sulfide, polyether sulfone, polysulfone, polyether ether sulfone, polyaryl ether sulfone, polyphenylenesulfone, polyphenylene sulfide sulfone, poly(phenyl sulfide-1,4-phenylene); polymers having C—N bonds in the backbone, for example polyimines, polyisocyamides, polyetherimine, polyetherimides, poly(trifluoromethylbis(phthalimide)phenyl), polyaniline, polyaramids, polyamides, polyhydrazides, polyUrethanes, polyimides, polyazoles, polyazole ether ketone, polyUreas, polyazines; liquid-crystalline polymers, in particular Vectra, and

inorganic polymers, for example polysilanes, polycarbosilanes, polysiloxanes, polysilicic acid, polysilicates, silicones, polyphosphazenes and polythiazyl.

These polymers may be used individually or as a mixture of two, three or more polymers.

Particular preference is given to polymers which contain at least one nitrogen atom, oxygen atom and/or sulfur atom in a repeat unit. Especially preferred are polymers which contain at least one aromatic ring having at least one nitrogen, oxygen and/or sulfur heteroatom per repeat unit. Within this group, preference is given in particular to polymers based on polyazoles. These basic polyazole polymers contain at least one aromatic ring with at least one nitrogen heteroatom per repeat unit.

The aromatic ring is preferably a five- or six-membered ring having from one to three nitrogen atoms which may be fused with another ring, in particular another aromatic ring.

Polymers based on polyazole generally contain repeat azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII) 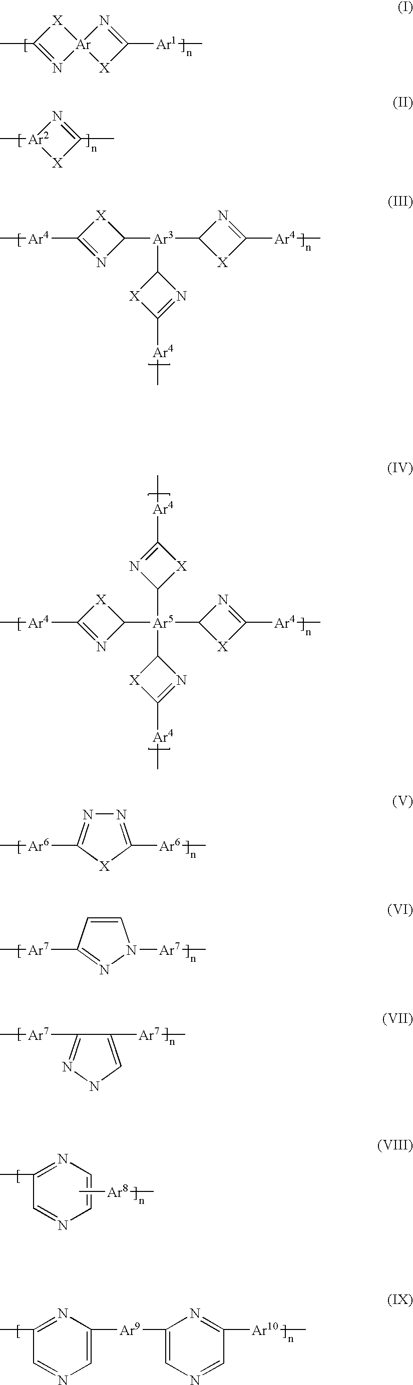 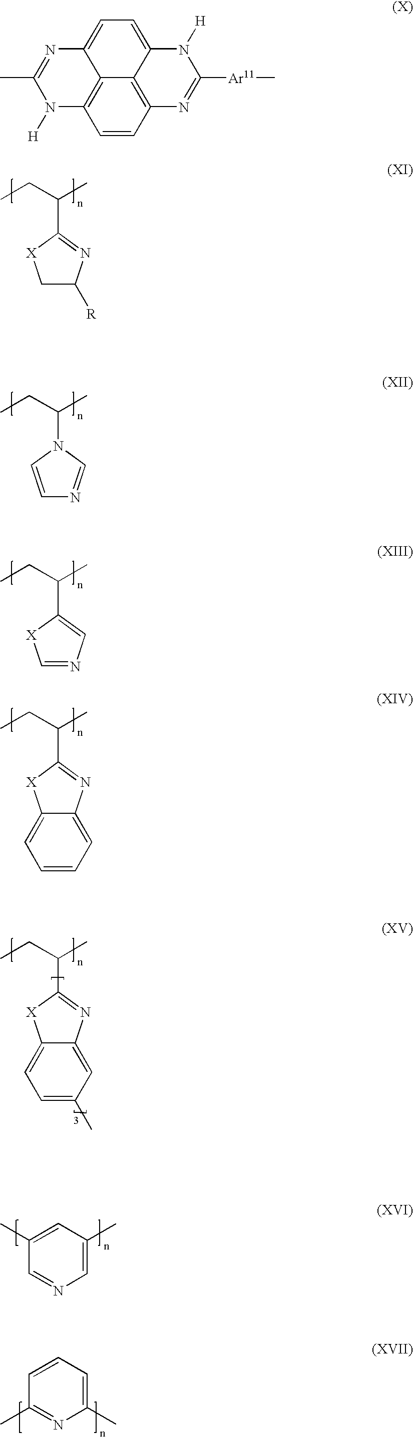 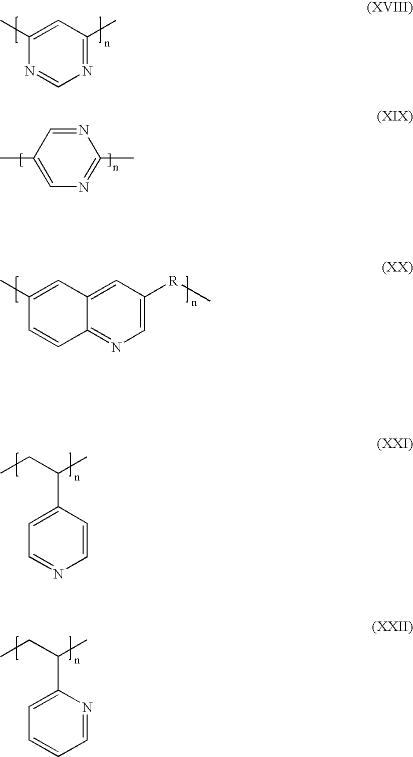
in which

Ar are the same or different and are each a tetravalent aromatic or heteroaromatic group which may be mono- or polycyclic,

Ar¹ are the same or different and are each a divalent aromatic or heteroaromatic group which may be mono- or polycyclic,

Ar² are the same or different and are each a di- or trivalent aromatic or heteroaromatic group which may be mono- or polycyclic,

Ar³ are the same or different and are each a trivalent aromatic or heteroaromatic group which may be mono- or polycyclic,

Ar⁴ are the same or different and are each a trivalent aromatic or heteroaromatic group which may be mono- or polycyclic,

Ar⁵ are the same or different and are each a tetravalent aromatic or heteroaromatic group which may be mono- or polycyclic,

Ar⁶ are the same or different and are each a divalent aromatic or heteroaromatic group which may be mono- or polycyclic,

Ar⁷ are the same or different and are each a divalent aromatic or heteroaromatic group which may be mono- or polycyclic,

Ar⁸ are the same or different and are each a trivalent aromatic or heteroaromatic group which may be mono- or polycyclic,

Ar⁹ are the same or different and are each a di- or tri- or tetravalent aromatic or heteroaromatic group which may be mono- or polycyclic,

Ar¹⁰ are the same or different and are each a di- or trivalent aromatic or heteroaromatic group which may be mono- or polycyclic,

Ar¹¹ are the same or different and are each a divalent aromatic or heteroaromatic group which may be mono- or polycyclic,

X are the same or different and are each oxygen, sulfur or an amino group which bears a hydrogen atom, a group having 1-20 carbon atoms, preferably a branched or unbranched alkyl or alkoxy group, or an aryl group as further radical,

R is the same or different and is hydrogen, an alkyl group and an aromatic group, with the proviso that R in formula (XX) is a divalent group, and

n, m are each an integer greater than or equal to 10, preferably greater than or equal to 100.

Preferred aromatic or heteroaromatic groups derive from benzene, naphthalene, biphenyl, diphenyl ether, diphenylmethane, diphenyldimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphen yl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]-thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanth roline and phenanthrene, which may optionally also be substituted.

The substitution pattern of Ar¹, Ar⁴, Ar⁶, Ar⁷, Ar⁸, Ar⁹, Ar¹⁰, Ar¹¹ is as desired; in the case of phenylene, for example, Ar¹, Ar⁴, Ar⁶, Ar⁷, Ar⁸, Ar⁹, Ar¹⁰, Ar¹¹ may be ortho-, meta- and para-phenylene. Particularly preferred groups derive from benzene and biphenylene, which may optionally also be substituted.

Preferred alkyl groups are short-chain alkyl groups having from 1 to 4 carbon atoms, for example methyl, ethyl, n- or isopropyl and tert-butyl groups.

Preferred aromatic groups are phenyl or naphthyl groups. The alkyl groups and the aromatic groups may be substituted.

Preferred substitutents are halogen atoms, for example fluorine, amino groups, hydroxyl groups or short-chain alkyl groups, for example methyl or ethyl groups.

Preference is given to polyazoles having repeat units of the formula (I) in which the X radicals are the same within one repeat unit.

The polyazoles may in principle also have different repeat units which differ, for example, in their X radical. However, it preferably has only identical X radicals in a repeat unit.

Further preferred polyazole polymers are polyimidazoles, polybenzothiazoles, polybenzooxazoles, polyoxadiazoles, polyquinoxalines, polythiadiazoles, poly(pyridines), poly(pyrimidines) and poly(tetraazapyrenes).

In a further embodiment of the present invention, the polymer containing repeat azole units is a copolymer or a blend which contains at least two units of the formula (I) to (XXII) which differ from one another. The polymers may be in the form of block copolymers (diblock, triblock), random copolymers, periodic copolymers and/or alternating polymers.

In a particularly preferred embodiment of the present invention, the polymer containing repeat azole units is a polyazole which contains only units of the formula (I) and/or (II).

The number of repeat azole units in the polymer is preferably an integer greater than or equal to 10. Particularly preferred polymers contain at least 100 repeat azole units.

In the context of the present invention, preference is given to polymers containing repeat benzimidazole units. Some examples of the highly appropriate polymers containing repeat benzimidazole units are represented by the following formulae: 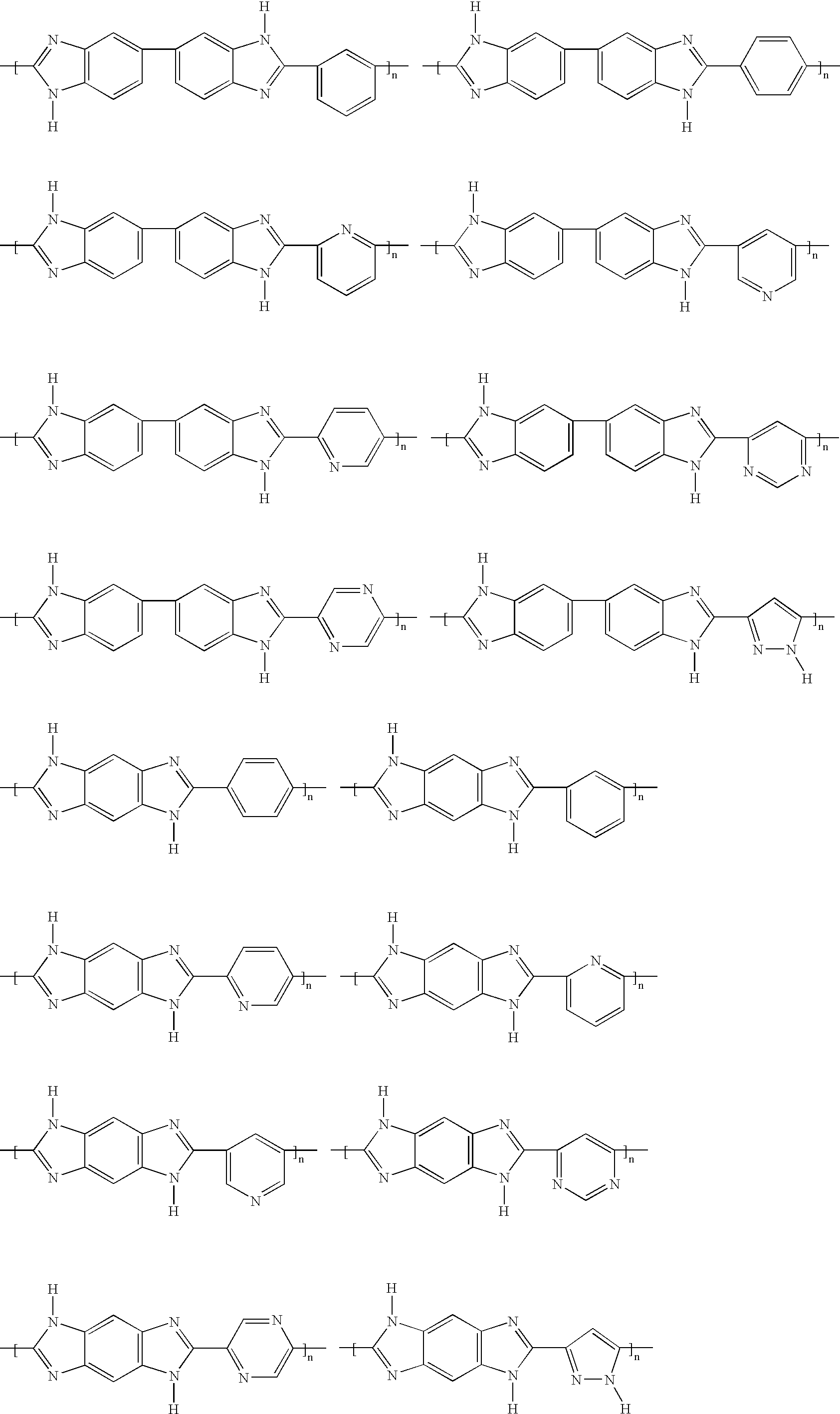 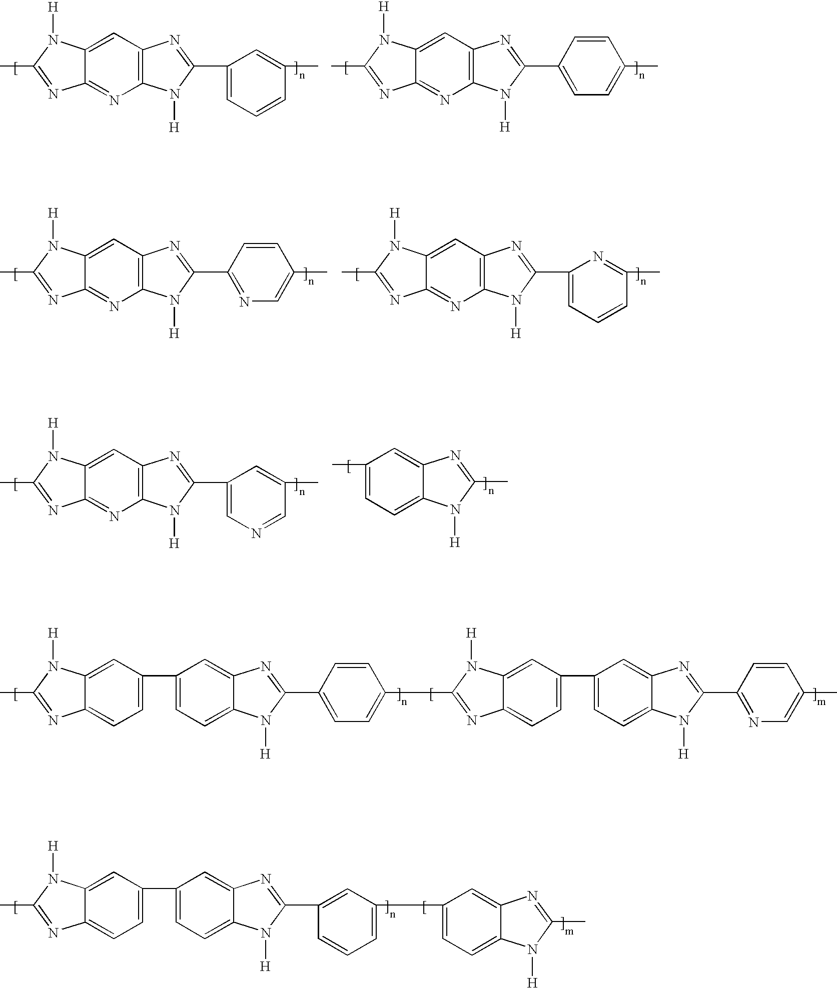
where n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Preferred polyazoles feature a high molecular weight. This is especially true of the polybenzimidazoles. Measured as the intrinsic viscosity, this is preferably at least 0.2 dl/g, preferably from 0.7 to 10 dl/g, in particular from 0.8 to 5 dl/g.

Processes for producing such membranes are described in H. P. Hentze, M. Antonietti “Porous polymers and resins” in F. Schüth, “Handbook of Porous Solids” p. 1964-2013.

Organic foams may also be produced as chemically inert carriers. These foams may be produced by releasing gases such as CO₂ in the synthesis of the organic polymer or using volatile liquids. Processes for producing organic foams are described in D. Klempner, K. C. Frisch “Handbook of Polymeric Foams and Foam Technology” and F. A. Shutov, Advances in Polymer Science, volume 73/74, 1985, pages 63-123. The pore former used may also be supercritical CO₂.

A particularly appropriate carrier is a phase separation membrane of polybenzimidazole, which can be produced as described in U.S. Pat. No. 4,693,824 or U.S. Pat. No. 4,666,996 or U.S. Pat. No. 5,091,087. Crosslinking by means of the process described in U.S. Pat. No. 4,634,530 allows the chemical stability of these membranes to be improved further.

The carrier materials used may also be expanded polymer films such as expanded Teflon. Processes for producing proton-conducting membranes by impregnating such an expanded perfluorinated membrane are described in U.S. Pat. No. 5,547,551.

The carrier materials used may likewise be highly porous thermosets which have been produced by chemically induced phase separation. In this process, a slightly volatile solvent is added to a mixture of a plurality of monomers capable of crosslinking. In the course of crosslinking, this solvent becomes insoluble and a heterogeneous polymer forms. Evaporation of the solvent forms a chemically inert, porous thermoset which can subsequently be impregnated with a liquid which comprises monomers comprising phosphonic acid groups.

Depending on the field of use, the flat structure according to step A) may be highly thermally stable. Highly thermally stable means that the carrier is stable at a temperature of at least 150° C., preferably at least 200° C. and more preferably at least 250° C. Stable means that the essential properties of the carrier are retained. For instance, no change in the mechanical properties or the chemical composition occurs upon exposure of the flat material for at least 1 hour.

The liquid which comprises monomers comprising phosphonic acid groups may be a solution, in which case the liquid may also comprise suspended and/or dispersed constituents. The viscosity of the liquid which comprises monomers comprising phosphonic acid groups can lie within wide ranges, and solvents can be added or the temperature can be increased to adjust the viscosity. The dynamic viscosity is preferably in the range from 0.1 to 10 000 mPa*s, in particular from 0.2 to 2000 mPa*s, and these values may be measured, for example, according to DIN 53015.

Monomers comprising phosphonic acid groups are known in the technical field. They are compounds which have at least one carbon-carbon double bond and at least one phosphonic acid group. The two carbon atoms which form the carbon-carbon double bond preferably have at least two, preferably 3, bonds to groups which lead to a low steric hindrance of the double bond. These groups include hydrogen atoms and halogen atoms, especially fluorine atoms. In the context of the present invention, the polymer comprising phosphonic acid groups arises from the polymerization product which is obtained by polymerization of the monomer comprising phosphonic acid groups alone or with further monomers and/or crosslinkers.

The monomer comprising phosphonic acid groups may comprise one, two, three or more carbon-carbon double bonds. In addition, the monomer comprising the phosphonic acid groups may comprise one, two, three or more phosphonic acid groups.

In general, the monomer comprising phosphonic acid groups comprises from 2 to 20, preferably from 2 to 10 carbon atoms.

The monomer comprising phosphonic acid groups used to prepare the polymers comprising phosphonic acid groups comprises preferably compounds of the formula 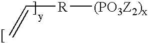
in which

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethylenebxy group or C5-C20-aryl or -heteroaryl group, where the above radicals may in turn be substituted by halogen, —OH, —CN, and

x is an integer of 1, 2, 3, 4, 5, 6, 7, 8, 9 or 10

y is an integer of 1, 2, 3, 4, 5, 6, 7, 8, 9 or 10
and/or of the formula 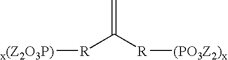
in which

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and

x is an integer of 1, 2, 3, 4, 5, 6, 7, 8, 9 or 10
and/or of the formula

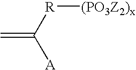

in which

A is a group of the formulae COOR², CN, CONR²₂, OR² and/or R², in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and

x is an integer of 1, 2, 3, 4, 5, 6, 7, 8, 9 or 10.

The preferred monomers comprising phosphonic acid groups include alkenes which have phosphonic acid groups, such as ethenephosphonic acid, propenephosphonic acid, butenephosphonic acid; acrylic acid and/or methacrylic acid compounds which have phosphonic acid groups, for example 2-phosphonomethylacrylic acid, 2-phosphonomethyl-methacrylic acid, 2-phosphonomethylacrylamide and 2-phosphonomethylmethacrylamide.

Particular preference is given to using commercial vinylphosphonic acid (ethenephosphonic acid), as obtainable, for example, from Aldrich or Clariant GmbH. A preferred vinylphosphonic acid has a purity of more than 70%, in particular 90% and more preferably more than 97% purity.

The monomers comprising phosphonic acid groups may additionally also be used in the form of derivatives which may subsequently be converted to the acid, in which case the conversion to the acid can also be effected in the polymerized state. These derivatives include in particular the salts, the esters, the amides and the halides of the monomers comprising phosphonic acid groups.

The liquid used in step A) comprises preferably at least 20% by weight, in particular at least 30% by weight and more preferably at least 50% by weight, based on the total weight of the mixture, of monomers comprising phosphonic acid groups.

The liquid used in step A) may additionally also comprise further organic and/or inorganic solvents. The organic solvents include in particular polar aprotic solvents such as dimethyl sulfoxide (DMSO), esters such as ethyl acetate, and polar protic solvents such as alcohols such as ethanol, propanol, isopropanol and/or butanol. The inorganic solvents include in particular water, phosphoric acid and polyphosphoric acid.

These can positively influence the processibility. The content of monomers comprising phosphonic acid groups in such liquids is generally at least 5% by weight, preferably at least 10% by weight, more preferably between 10 and 97% by weight.

In a particular aspect of the present invention, the polymers comprising phosphonic acid groups can be prepared by using compositions which comprise monomers comprising sulfonic acid groups.

Monomers comprising sulfonic acid groups are known in the technical field. They are compounds which have at least one carbon-carbon double bond and at least one sulfonic acid group. The two carbon atoms which form the carbon-carbon double bond preferably have at least two, preferably 3 bonds to groups which lead to low steric hindrance of the double bond. These groups include hydrogen atoms and halogen atoms, especially fluorine atoms. In the context of the present invention, the polymer comprising sulfonic acid groups arises from the polymerization product which is obtained by polymerization of the monomer comprising sulfonic acid groups alone or with further monomers and/or crosslinkers.

The monomer comprising sulfonic acid groups may comprise one, two, three or more carbon-carbon double bonds. Moreover, the monomer comprising sulfonic acid groups may comprise one, two, three or more sulfonic acid groups.

In general, the monomer comprising sulfonic acid groups comprises from 2 to 20, preferably from 2 to 10 carbon atoms.

The monomer comprising sulfonic acid groups comprises preferably compounds of the formula 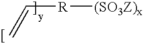
in which

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and

x is an integer of 1, 2, 3, 4, 5, 6, 7, 8, 9 or 10

y is an integer of 1, 2, 3, 4, 5, 6, 7, 8, 9 or 10
and/or of the formula 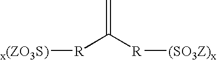
in which

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and

x is an integer of 1, 2, 3, 4, 5, 6, 7, 8, 9 or 10
and/or of the formula

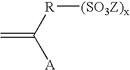

in which

A is a group of the formulae COOR², CN, CONR²₂, OR² and/or R², in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂

R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,

Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and

x is an integer of 1, 2, 3, 4, 5, 6, 7, 8, 9 or 10.

The preferred monomers comprising sulfonic acid groups include alkenes which have sulfonic acid groups, such as ethenesulfonic acid, propenesulfonic acid, butenesulfonic acid; acrylic acid and/or methacrylic acid compounds which have sulfonic acid groups, for example 2-sulfonomethylacrylic acid, 2-sulfonomethylmethacrylic acid, 2-sulfonomethylacrylamide and 2-sulfonomethylmethacrylamide.

Particular preference is given to using commercial vinylsulfonic acid (ethenesulfonic acid), as obtainable, for example, from Aldrich or Clariant GmbH. A preferred vinylsulfonic acid has a purity of more than 70%, in particular 90% and more preferably more than 97% purity.

The monomers comprising sulfonic acid groups may additionally also be used in the form of derivatives which can subsequently be converted to the acid, in which case the conversion to the acid can also be effected in the polymerized state. These derivatives include in particular the acids, the esters, the amides and the halides of the monomers comprising sulfonic acid groups.

In a particular aspect of the present invention, the weight ratio of monomers comprising sulfonic acid groups to monomers comprising phosphonic acid groups may be in the range from 100:1 to 1:100, preferably from 10:1 to 1:10 and more preferably from 2:1 to 1:2.

In a further embodiment of the invention, monomers capable of crosslinking may be used in the production of the polymer membrane. These monomers may be added to the liquid according to step A).

The monomers capable of crosslinking are in particular compounds which have at least 2 carbon-carbon double bonds. Preference is give to dienes, trienes, tetraenes, dimethyl-acrylates, trimethylacrylates, tetramethylacrylates, diacrylates, triacrylates, tetraacrylates.

Particular preference is given to dienes, trienes, tetraenes of the formula 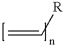
dimethylacrylates, trimethylacrylates, tetramethylacrylates of the formula 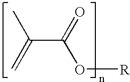
diacrylates, triacrylates, tetraacrylates of the formula 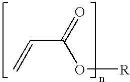
in which

R is a C1-C15-alkyl group, C5-C20-aryl or -heteroaryl group, NR′, —SO₂, PR′, Si(R′)₂, where the above radicals may themselves be substituted,

R′ are each independently hydrogen, a C1-C15-alkyl group, C1-C15-alkoxy group, C5-C20-aryl or -heteroaryl group and

n is at least 2.

The substitutents of the aforementioned R radical are preferably halogen, hydroxyl, carboxy, carboxyl, carboxyl ester, nitriles, amines, silyl, siloxane radicals.

Particularly preferred crosslinkers are allyl methacrylate, ethylene glycol dimethacrylate, diethylene glycol dimethacrylate, triethylene glycol dimethacrylate, tetra- and polyethylene glycol dimethacrylate, 1,3-butanediol dimethacrylate, glycerol dimethacrylate, diurethane dimethacrylate, trimethylpropane trimethacrylate, epoxyacrylates, for example Ebacryl, N′,N-methylenebisacrylamide, carbinol, butadiene, isoprene, chloroprene, divinylbenzene and/or bisphenol A dimethylacrylate. These compounds are commercially available, for example, from Sartomer Company Exton, Pa. under the designations CN-120, CN104 and CN-980.

The use of crosslinkers is optional, these compounds being usable typically in the range between 0.05 to 30% by weight, preferably from 0.1 to 20% by weight, more preferably 1 and 10% by weight, based on the weight of the monomers comprising phosphonic acid groups.

A further polymer may be added to the liquid used in step A). This polymer may, inter alia, be present in dissolved, dispersed or suspended form. These polymers have been described by way of example as organic carrier material, and reference is made thereto.

Preferred polymers which are added to the liquid in step A) preferred polymers include polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyvinyl difluoride, polyhexafluoropropylene, polyethylene-tetrafluoroethylene, copolymers of PTFE with hexafluoropropylene, with perfluoropropyl vinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular those of norbornene; polymers having C—O bonds in the backbone, for example polyacetal, polyoxymethylene, polyethers, polypropylene oxide, polyepichlorohydrin, polytetrahydrofuran, polyphenylene oxide, polyether ketone, polyether ether ketone, polyether ketone ketone, polyether ether ketone ketone, polyether ketone ether ketone ketone, polyesters, in particular polyhydroxyacetic acid, polyethylene terephthalate, polybutylene terephthalate, polyhydroxybenzoate, polyhydroxypropionic acid, polypropionic acid, polypivalolactone, polycaprolactone, furan resins, phenol-aryl resins, polymalonic acid, polycarbonate; polymers having C—S bonds in the backbone, for example polysulfide ethers, polyphenylene sulfide, polyether sulfone, polysulfone, polyether ether sulfone, polyaryl ether sulfone, polyphenylenesulfone, polyphenylene sulfide sulfone, poly(phenyl sulfide-1,4-phenylene); polymers having C—N bonds in the backbone, for example polyimines, polyisocyamides, polyetherimine, polyetherimides, poly(trifluoromethylbis(phthalimide)phenyl), polyaniline, polyaramids, polyamides, polyhydrazides, polyUrethanes, polyimides, polyazoles, polyazole ether ketone, polyUreas, polyazines; liquid-crystalline polymers, in particular Vectra, and inorganic polymers, for example polysilanes, polycarbosilanes, polysiloxanes, polysilicic acid, polysilicates, silicones, polyphosphazenes and polythiazyl. These polymers may be used individually or as a mixture of two, three or more polymers.

Particular preference is given to polymers which contain at least one nitrogen atom, oxygen atom and/or sulfur atom in a repeat unit. Especially preferred are polymers which contain at least one aromatic ring having at least one nitrogen, oxygen and/or sulfur heteroatom per repeat unit. Within this group, preference is given in particular to polymers based on polyazoles. These basic polyazole polymers contain at least one aromatic ring with at least one nitrogen heteroatom per repeat unit.

To further improve the performance properties, it is possible additionally to add to the membrane fillers, especially proton-conducting fillers, and also additional acids. Such substances preferably have an intrinsic conductivity at 100° C. of at least 10⁻⁶ S/cm, in particular 10⁻⁵ S/cm. The addition can be effected, for example, in step A). In addition, these additives, if they are present in liquid form, may also be added after the polymerization in step B).

Nonlimiting examples of proton-conducting fillers are

sulfates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,

phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,

polyacids such as H₃PW₁₂O₄₀.nH₂O (n=21-29), H₃SiW₁₂O₄₀ nH₂O (n=21-29), HₓWO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄

selenites and arsenides such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,

phosphides such as ZrP, TiP, HfP

oxides such as Al₂O₃, Sb₂O₅, ThO₂, SnO₂, ZrO₂, MoO₃

silicates such as zeolites, zeolites(NH₄+), sheet silicates, framework silicates, H-natrolites, H-mordenites, NH₄-analcines, NH₄-sodalites, NH₄-gallates, H-montmorillonites

acids such as HClO₄, SbF₅

fillers such as carbides, in particular SiC, Si₃N₄, fibers, in particular glass fibers, glass powders and/or polymer fibers, preferably ones based on polyazoles.

These additives may be present in customary amounts in the proton-conducting polymer membrane, although the positive properties, such as high conductivity, long lifetime and high mechanical stability of the membrane, should not be impaired all too greatly by addition of excessively large amounts of additives. In general, the membrane after the polymerization in step B) comprises not more than 80% by weight, preferably not more than 50% by weight and more preferably not more than 20% by weight of additives.

In addition, this membrane may further comprise perfluorinated sulfonic acid additives (preferably 0.1-20% by weight, more preferably 0.2-15% by weight, very particularly preferably 0.2-10% by weight). These additives lead to an increase in power, to an increase in the oxygen solubility and oxygen diffusion in the vicinity of the cathode and to a reduction in the absorption of phosphoric acid and phosphate to platinum. (Electrolyte additives for phosphoric acid fuel cells. Gang, Xiao; Hjuler,. H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and perfluorosulfonimide as an additive in phosphoric acid fuel cell. Razaq, M.; Razaq, A.; Yeager, E.; DesMarteau, Darryl, D.; Singh, S. Case Cent. Electrochem. Sci., Case West, Reserve Univ., Cleveland, Ohio, USA. J. Electrochem. Soc. (1989), 136(2), 385-90.)

Nonlimiting examples of perfluorinated sulfonic acid additives are:

trifluoromethanesulfonic acid, potassium trifluoromethanesulfonate, sodium trifluoro-methanesulfonate, lithium trifluoromethanesulfonate, ammonium trifluoromethanesulfonate, potassium perfluorohexanesulfonate, sodium perfluorohexanesulfonate, lithium perfluoro-hexanesulfonate, am monium perfluorohexanesul fonate, perfluorohexanesulfonic acid, potassium nonafluorobutanesulfonate, sodium nonafluorobutanesulfonate, lithium nonafluorobutanesulfonate, ammonium nonafluorobutanesulfonate, cesium nonafluoro-butanesulfonate, triethylammonium perfluorohexanesulfonate and perfluorosulfonimides.

The polymerization of the monomers comprising phosphonic acid groups in step B) is preferably effected by free-radical means. Free-radical formation can be effected thermally, photochemically, chemically and/or electrochemically.

For example, an initiator solution which comprises at least one substance capable of forming free radicals can be added to the liquid in step A). In addition, an initiator solution can be applied to the imbibed carrier material. This can be done by methods known per se from the prior art (for example spraying, dipping, etc.).

Suitable free-radical formers include azo compounds, peroxy compounds, persulfate compounds or azoamidines. Nonlimiting examples are dibenzoyl peroxide, dicumene peroxide, cumene hydroperoxide, diisopropyl peroxydicarbonate, bis(4-tert-butylcyclohexyl) peroxydicarbonate, dipotassium persulfate, ammonium peroxydisulfate, 2,2′-azobis(2-methylpropionitrile) (AIBN), 2,2′-azobis(isobutyroamidine) hydrochloride, benzopinacol, dibenzyl derivatives, methylethylene ketone peroxide, 1,1-azobiscyclohexanecarbonitrile, methyl ethyl ketone peroxide, acetylacetone peroxide, dilauryl peroxide, didecanoyl peroxide, tert-butyl per-2-ethylhexanoate, ketone peroxide, methyl isobutyl ketone peroxide, cyclo-hexanone peroxide, dibenzoyl peroxide, tert-butyl peroxybenzoate, tert-butyl peroxyiso-propylcarbonate, 2,5-bis(2-ethylhexanoylperoxy)-2,5-dimethylhexane, tert-butyl peroxy-2-ethylhexanoate, tert-butyl peroxy-3,5,5-trimethylhexanoate, tert-butyl peroxyisobutyrate, tert-butyl peroxyacetate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate and also the free-radical formers obtainable from DuPont under the name ®Vazo, for example ®Vazo V50 and ®Vazo Ws.

In addition, it is also possible to use free-radical formers which form free radicals upon irradiation. Preferred compounds include α,α-diethoxyacetophenone (DEAP, Upjohn Corp), n-butylbenzoin ether (®Trigonal-14, AKZO) and 2,2-dimethoxy-2-phenylacetophenone (®Irgacure 651) and 1-benzoylcyclohexanol (®Irgacure 184), bis(2,4,6-trimethylbenzoyl)-phenylphosphine oxide (®Irgacure 819) and 1-[4-(2-hydroxyethoxy)phenyl]-2-hydroxy-2-phenylpropan-1-one (®Irgacure 2959), each of which are commercially available from Ciba Geigy Corp.

Typically between 0.0001 and 5% by weight, in particular between 0.01 and 3% by weight (based on the weight of the monomers comprising phosphonic acid groups) of free-radical formers are added. The amount of free-radical formers can be varied depending on the desired degree of polymerization.

The polymerization can also be effected by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV).

The polymerization can also be effected by action of UV light having a wavelength of less than 400 nm. This polymerization method is known per se and is described, for example, in Hans Joerg Elias, Makromolekulare Chemie [Macromolecular Chemistry], 5th edition, volume 1, pp. 492-511; D. R. Arnold, N. C. Baird, J. R. Bolton, J. C. D. Brand, P. W. M. Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerization can also be achieved by the action of β-rays, γ-rays and/or electron beams. In a particular embodiment of the present invention, a membrane is irradiated with a radiation dose in the range from 1 to 300 kGy, preferably from 3 to 250 kGy and most preferably from 20 to 200 kGy.

The polymerization of the monomers comprising phosphonic acid groups in step B) is effected preferably at temperatures above room temperature (20° C.) and less than 200° C., in particular at temperatures between 40° C. and 150° C., more preferably between 50° C. and 120° C. The polymerization is effected preferably under atmospheric pressure, but can also be effected under the action of pressure. The polymerization may lead to a strengthening of the flat structure, and this strengthening can be monitored by microhardness measurement. The increase in hardness resulting from the polymerization is preferably at least 20%, based on the hardness of the imbibed carrier material.

In a particular embodiment of the present invention, the membranes have a high mechanical stability. This parameter arises from the hardness of the membrane, which is determined by means of microhardness measurement to DIN 50539. For this purpose, the membrane is loaded with a Vickers diamond gradually up to a force of 3 mN within 20 s and the penetration depth is determined. According to this, the hardness at room temperature is at least 0.01 N/mm², preferably at least 0.1 N/mm² and most preferably at least 1 N/mm², without any intention that this should impose a restriction. Subsequently, the force is kept constant at 3 mN over 5 s and the creep from the penetration depth is calculated. In the case of preferred membranes, the creep C_{HU} 0.003/20/5 under these conditions is less than 20%, preferably less than 10% and most preferably less than 5%. The modulus YHU determined by means of microhardness measurement is at least 0.5 MPa, in particular at least 5 MPa and most preferably at least 10 MPa, without any intention that this should impose a restriction.

The degree of polymerization of the polymers comprising phosphonic acid groups present in the inventive membrane is not critical. The degree of polymerization is preferably at least 2, in particular at least 5, more preferably at least 30 repeat units, in particular at least 50 repeat units, most preferably at least 100 repeat units. This degree of polymerization is determined via the number-average molecular weight. Mₙ, which can be determined by GPC methods. Owing to the problems of isolating the polymers comprising phosphonic acid groups present in the membrane without degradation, this value is determined with the aid of a sample which is carried out by polymerization of monomers comprising phosphonic acid groups without addition of polymer. In this case, the proportion by weight of monomers comprising phosphonic acid groups and of free-radical initiator is kept constant in comparison to the conditions of the production of the membrane. The conversion which is achieved in a comparative polymerization is preferably greater than or equal to 20%, in particular greater than or equal to 40% and more preferably greater than or equal to 75%, based on the monomers comprising phosphonic acid groups used.

The polymers comprising phosphonic acid groups present in the membrane preferably have a broad molecular weight distribution. Thus, the polymers comprising phosphonic acid groups may have a polydispersity M_{w}/Mₙ in the range from 1 to 20, more preferably from 3 to 10.

The water content of the proton-conducting membrane is preferably at most 15% by weight, more preferably at most 10% by weight and most preferably at most 5% by weight.

In this connection, it can be assumed that the conductivity of the membrane may be based on the Grotthus mechanism, as a result of which the system does not require any additional moistening. Accordingly, preferred membranes comprise fractions of low molecular weight polymers comprising phosphonic acid groups. Thus, the fraction of polymers which comprise phosphonic acid groups and have a degree of polymerization in the range from 2 to 20 may preferably be at least 10% by weight, more preferably at least 20% by weight, based on the weight of the polymers comprising phosphonic acid groups.

The polymerization in step B) may lead to a decrease in the layer thickness. The thickness of the self-supporting membrane is preferably between 15 and 1000 μm, preferably between 20 and 500 μm, in particular between 30 and 250 μm.

After the polymerization in step B), the membrane may be crosslinked on the surface thermally, photochemically, chemically and/or electrochemically. This curing of the membrane surface additionally improves the properties of the membrane.

In a particular aspect, the membrane may be heated to a temperature of at least 150° C., preferably at least 200° C. and more preferably at least 250° C. Preference is given to effecting the thermal crosslinking in the presence of oxygen. In this process step, the oxygen concentration is typically in the range from 5 to 50% by volume, preferably from 10 to 40% by volume, without any intention that this should impose a restriction.

The crosslinking can also be effected by the action of IR or NIR (IR=infrared, i.e. light having a wavelength of more than 700 nm; NIR=near IR, i.e. light having a wavelength in the range from approx. 700 to 2000 nm or an energy in the range from approx. 0.6 to 1.75 eV) and/or UV light. A further method is irradiation with β-rays, γ-rays and/or electron beams. The radiation dose in this case is preferably between 5 and 250 kGy, in particular from 10 to 200 kGy. The irradiation can be effected under air or under inert gas. As a result, the use properties of the membrane, especially its lifetime, are improved.

Depending on the desired degree of crosslinking, the duration of the crosslinking reaction may lie within a wide range. In general, this reaction time is in the range from 1 second to 10 hours, preferably from 1 minute to 1 hour, without any intention that this should impose a restriction.

In a particular embodiment of the present invention, the membrane comprises at least 3% by weight, preferably at least 5% by weight and more preferably at least 7% by weight of phosphorus (as the element), based on the total weight of the membrane. The proportion of phosphorus can be determined by means of an elemental analysis. For this purpose, the membrane is dried at 110° C. for 3 hours under reduced pressure (1 mbar).

The polymers comprising phosphonic acid groups preferably have a content of phosphonic acid groups of at least 5 meq/g, more preferably at least 10 meq/g. This value is determined via the so-called ion exchange capacity (IEC).

To measure the IEC, the phosphonic acid groups are converted to the free acid, the measurement being effected before polymerization of the monomers comprising phosphonic acid groups. The sample is subsequently titrated with 0.1 M NaOH. From the consumption of the acid up to the equivalence point and the dry weight, the ion exchange capacity (IEC) is then calculated.

The inventive polymer membrane has improved material properties compared to the doped polymer membranes known to date. In particular, in comparison to known undoped polymer membranes, they already exhibit intrinsic conductivity. The reason for this is in particular the presence of polymers comprising phosphonic acid groups.

The inventive polymer membrane has improved material properties compared to the doped polymer membranes known to date. In particular, in comparison with known doped polymer membranes, they exhibit better performances. The reason for this is in particular an improvement in proton conductivity. At temperatures of 120° C., this is at least 1 mS/cm, preferably at least 2 mS/cm, in particular at least 5 mS/cm, preferably measured without moistening.

In addition, the membranes may have a high conductivity even at a temperature of 70° C. The conductivity is dependent upon factors including sulfonic acid group content of the membrane. The higher this content is, the better the conductivity at low temperatures. In this context, an inventive membrane can be moistened at low temperatures. For this purpose, for example, the compound used as the energy source, for example hydrogen, can be provided with a fraction of water. In many cases, however, even the water formed by the reaction is sufficient to achieve moistening.

The specific conductivity is measured by means of impedance spectroscopy in a 4-pole arrangement in potentiostatic mode and using platinum electrodes (wire, diameter 0.25 mm). The distance between the current-collecting electrodes is 2 cm. The resulting spectrum is evaluated with a simple model consisting of a parallel arrangement of an ohmic resistance and a capacitor. The sample cross section of the phosphoric acid-doped membrane is measured immediately before the sample is mounted. To measure the temperature dependence, the test cell is brought to the desired temperature in an oven and controlled via a Pt-100 thermoelement positioned in the immediate vicinity of the sample. After the temperature has been attained, the sample is kept at this temperature for 10 minutes before the start of the measurement.

The crossover current density in operation with 0.5 M methanol solution and at 90° C. in a so-called liquid direct methanol fuel cell is preferably less than 100 mA/cm², in particular less than 70 mA/cm², more preferably less than 50 mA/cm² and most preferably less than 10 mA/cm². The crossover current density in operation with a 2 M methanol solution and at 160° C. in a so-called gaseous direct methanol fuel cell is preferably less than 100 mA/cm², in particular less than 50 mA/cm², most preferably less than 10 mA/cm².

To determine the crossover current density, the amount of carbon dioxide which is released at the cathode is measured by means of a CO₂ sensor. From the value of the amount of CO₂ thus obtained, as described by P. Zelenay, S.C. Thomas, S. Gottesfeld in S. Gottesfeld, T. F. Fuller “Proton Conducting Membrane Fuel Cells II” ECS Proc. Vol. 98-27 p. 300-308, the crossover current density is calculated.

Possible fields of use of the inventive intrinsically conductive polymer membranes include use in fuel cells, in electrolysis, in capacitors and in battery systems. Owing to their property profile, the polymer membranes may preferably be used in fuel cells, in particular in DMFC fuel cells (direct methanol fuel cell).

The present invention also relates to a membrane-electrode unit which has at least one inventive polymer membrane. The membrane-electrode unit has a high performance even at a low content of catalytically active substances, for example platinum, ruthenium or palladium. For this purpose, gas diffusion layers provided with a catalytically active layer may be used.

The gas diffusion layer generally exhibits an electron conductivity. Typically, flat, electrically conducting and acid-resistant structures are used for this purpose. These include, for example, carbon fiber papers, graphitized carbon fiber papers, carbon fiber fabric, graphitized carbon fiber fabric and/or flat structures which have been made conductive by addition of carbon black.

The catalytically active layer comprises a catalytically active substance. These include noble metals, especially platinum, palladium, rhodium, iridium and/or ruthenium. These substances may also be used in the form of alloys with one another. In addition, these substances may also be used in alloy with base metals, for example Cr, Zr, Ni, Co and/or Ti. In addition, it is also possible to use the oxides of the aforementioned noble metals and/or base metals. In a particular aspect of the present invention, the catalytically active compounds are used in the form of particles which preferably have a size in the range of from 1 to 1000 nm, in particular from 10 to 200 nm and preferably from 20 to 100 nm.

Moreover, the catalytically active layer may comprise customary additives. These include fluoropolymers, for example polytetrafluoroethylene (PTFE) and surface-active substances.

In a particular embodiment of the present invention, the weight ratio of fluoropolymer to catalyst material comprising at least one noble metal and optionally one or more support materials is greater than 0.1, this ratio preferably being in the range from 0.2 to 0.6.

In a particular embodiment of the present invention, the catalyst layer has a thickness in the range from 1 to 1000 μm, in particular from 5 to 500, preferably from 10 to 300 μm. This value constitutes a mean value which can be determined by measuring the layer thickness in the cross section of images which can be obtained with a scanning electron microscope (SEM).

In a particular embodiment of the present invention, the noble metal content of the catalyst layer is from 0.1 to 10.0 mg/cm², preferably from 0.2 to 6.0 mg/cm² and more preferably from 0.3 to 3.0 mg/cm². These values may be determined by elemental analysis of a flat sample.

For further information on membrane-electrode units, reference is made to the technical literature, in particular to the patent applications WO 01/18894 A2, DE 195 09 748, DE 195 09 749, WO 00/26982, WO 92/15121 and DE 197 57 492. The disclosure present in the aforementioned references with regard to the structure and the production of membrane-electrode units, and also the electrodes, gas diffusion layers and catalysts to be selected, also forms part of the description.

In a further variant, a catalytically active layer may be applied to the inventive membrane and the former can be bonded to a gas diffusion layer.

In one variant of the present invention, the membrane can also be formed, instead of on a support, directly on the electrode. Such a membrane also forms part of the subject matter of the present invention.

In a further variant, a catalytically active layer may be applied to the inventive membrane and the former may be bonded to a gas diffusion layer. To this end, a membrane may be formed and the catalyst applied. These structures too form part of the subject matter of the present invention.

The present invention likewise provides a membrane-electrode unit which has at least one coated electrode and/or at least one inventive polymer membrane.

1. A proton-conducting polymer membrane comprising polymers comprising at least one porous carrier material and polymers comprising phosphonic acid groups, obtainable by polymerizing monomers comprising phosphonic acid groups.

2. The proton-conducting polymer membrane as claimed in claim 1, obtainable by a process comprising the steps of
A) imbibing at least one porous carrier material with a liquid which comprises monomers comprising phosphonic acid groups, and
B) polymerizing at least some of the monomers comprising phosphonic acid groups which have been introduced into the polymer film in step A).

3. The membrane as claimed in claim 1, characterized in that the polymers comprising phosphonic acid groups are prepared by using a monomer comprising phosphonic acid groups of the formula 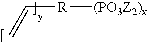
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10,
y is an integer of 1, 2, 3, 4, 5, 6, 7, 8, 9 or 10,
and/or of the formula 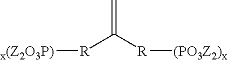
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10,
and/or of the formula 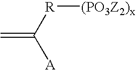
in which
A is a group of the formulae COOR², CN, CONR²₂, OR² and/or R²,
in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂,
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

4. The membrane as claimed in claim 1, characterized in that the polymers comprising phosphonic acid groups are prepared by using a monomer comprising sulfonic acid groups of the formula 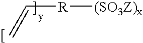
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10,
y is an integer of 1, 2, 3, 4, 5, 6, 7, 8, 9 or 10,
and/or of the formula 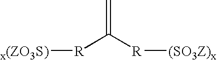
in which
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10,
and/or of the formula 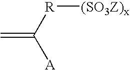
in which
A is a group of the formulae COOR², CN, CONR²₂, OR² and/or R²,
in which R² is hydrogen, a C1-C15-alkyl group, C1-C15-alkoxy group, ethyleneoxy group or C5-C20-aryl or -heteroaryl group, where the above radicals may in turn be substituted by halogen, —OH, COOZ, —CN, NZ₂,
R is a bond, a divalent C1-C15-alkylene group, divalent C1-C15-alkyleneoxy group, for example ethyleneoxy group, or divalent C5-C20-aryl or -heteroaryl group, where the above radicals may in turn be substituted by halogen, —OH, COOZ, —CN, NZ₂,
Z are each independently hydrogen, C1-C15-alkyl group, C1-C15-alkoxy group, ethyleneoxy group or C5-C20-aryl or -heteroaryl group, where the above radicals may in turn be substituted by halogen, —OH, —CN, and
x is an integer of 1, 2, 3, 4, 5, 6, 7, 8, 9 or 10.

5. The membrane as claimed in claim 1, characterized in that the polymers comprising phosphonic acid groups are prepared by using monomers which are capable of crosslinking and have at least 2 carbon-carbon double bonds.

6. The membrane as claimed in claim 1, characterized in that the liquid used in step A) additionally comprises dispersed and/or suspended polymer.

7. The membrane as claimed in claim 1, characterized in that the carrier material comprises at least one inorganic material.

8. The membrane as claimed in claim 1, characterized in that the carrier material comprises at least one organic polymer.

9. The membrane as claimed in claim 1, characterized in that the pores of the carrier material have a size in the range from 1 nm to 1000 nm.

10. The membrane as claimed in claim 1, characterized in that the pores of the carrier material have a volume in the range from 1 nm³ to 1 μm³.

11. The membrane as claimed in claim 1, characterized in that the free pore volume of the carrier material is at least 90% by volume based on the volume of the carrier material.

12. The membrane as claimed in claim 1, characterized in that polymer membrane is crosslinked by the action of oxygen.

13. The membrane as claimed in claim 1, characterized in that the polymer membrane has a thickness between 15 and 3000 μm.

14. The membrane as claimed in claim 1, characterized in that the weight ratio of polymer comprising phosphonic acid groups to the carrier material is in the range from 4:1 to 100:1.

15. A membrane-electrode unit comprising at least one electrode and at least one membrane as claimed in claim 1.

16. A fuel cell comprising one or more membrane-electrode units as claimed in claim 15.
